(19) United States
(12) Patent Application Publication
(10) Pub. No.: US 2014/0159296 A1
(43) Pub. Date: Jun. 12, 2014

(54) SPRING SYSTEM FOR AN AIRCRAFT

(71) Applicant: Viktor Kast, Biberach (DE)

(72) Inventor: Viktor Kast, Biberach (DE)

(73) Assignee: LIEBHERR-AEROSPACE LINDENBERG GMBH, Lindenberg/Allgäu (DE)

(21) Appl. No.: 14/235,479

(22) PCT Filed: Jul. 23, 2012
(86) PCT No.: PCT/EP2012/003097

§ 371 Date: Jan. 28, 2014

(30) Foreign Application Priority Data
Jul. 28, 2011 (DE) 10 2011 108 852.4

(51) Int. Cl. F16F 1/12; B64C 25/02

(52) U.S. Cl. CPC F16F 1/125; B64C 25/02
USPC 267/179

(57) ABSTRACT

A spring system includes at least one spring and at least one spring receiver including at least one lug head to which the spring is attachable or is attached, wherein the lug head includes a thread onto which the spring can be screwed on or is screwed on, and the thread includes at least one thread portion including a thread pitch in the range of an operating pitch of the spring.

### CROSS REFERENCE TO RELATED APPLICATIONS AND CLAIM OF PRIORITY

This patent application is a National Phase application under 35 U.S.C. §371 of International Application No. PCT/EP2012/003097, filed 23 Jul. 2012 which claims priority to German Patent Application No. 10 2011 108 852.4, filed 28 Jul. 2011, entire contents of which are incorporated herein by reference.

### BACKGROUND

1. Field of the Invention

The present invention relates to a spring system and a landing gear chassis with at least one spring system as described herein.

2. Description of the Related Art

In spring systems for aircraft, more specifically, landing gear suspension systems or chassis for an aircraft, a tension spring is usually mounted on a spring receiving means. This spring receiving means includes, for example, a lug head or a sleeve onto which a screw thread with a constant thread pitch, wherein the pitch is approximately equal to the spring in an unloaded or unstressed condition, is screwed on.

Since the pitch of the spring, near the beginning of the thread, may be dramatically changed due to the tensioning operation of the spring, the spring will tend to jump out of the first turn of the thread, or may even undergo a plastic deformation. A plastic deformation, for example, may be a permanent gap or kinked formation of the spring as a result of the extensive tensioning operation of the spring.

Ameliorative approaches related to the phenomenon described above using so-called pre-cylinders wherein certain material pairings, such as stainless steel and titanium, turned out to be disadvantageous because these constructions were quite susceptible to seizing. For example, the inner diameter of the titanium spring scrapes on both the pre-cylinder and the last thread groove of the lug head made of stainless steel thereby causing seizures.

It has also been attempted to prevent the spring from jumping out or deforming by employing bonded connections. These approaches, however, have disadvantages in that the fatigue strength or stability of the spring is not high.

Therefore, one embodiment of the present invention provides a spring system with increased durability and a safer attachment of the spring to the spring system.

### SUMMARY

In one embodiment of the present invention, a spring system for an aircraft is provided with at least one spring and with at least one spring receiving means, wherein the spring receiving means includes at least one lug head to which the spring is attachable or is attached, wherein the lug head includes a thread onto which the spring can be screwed on or is screwed on, and the thread includes at least one thread portion which has a thread pitch in the range of the operating pitch of the spring.

In one embodiment, the aircraft may be an airplane and the spring system, in particular, may be a spring system for the landing gear chassis of an aircraft. The spring, in particular, can be a tension spring (i.e., a spring subjected to tension).

The operating pitch of the spring, in particular, corresponds to the pitch of the spring reached in the operation of the spring (i.e., the pitch of the spring in the loaded condition). This pitch of the spring is determined by the elongation of the spring to a certain length or a certain length range, to which the spring is expanded or deflected in operation.

In particular, this provides a reduction of the deformations and the forces is achieved at the transition from the clamping region of the spring, which is attached to the spring receiving means, and the resilient region of the spring. As a result, the spring deformation and the spring force are built up slowly. In particular, the spring is no longer prone to the so-called jumping out phenomenon (i.e., the thread jumping out as a result of the load), because the forces governing the jumping out are minimized very simply and effectively from the start. In particular, since the deformation is greatly reduced in this region, the spring can no longer jump out of the first thread groove of the lug head.

In one embodiment, it is possible to use a shorter lug head, because the forces to be transmitted are reduced or can be reduced. By using a shorter lug head, the weights and materials of construction may also be advantageously saved. This may also provide a stiffness jump at the end of the thread that can be greatly reduced. Similarly, no more rubbing takes place at the pre-cylinder or at the spring receiving means, and rubbing between the first thread groove and the spring is also distinctly reduced. Lastly, the fatigue strength of the spring can be distinctly increased.

In one embodiment, the spring can be a titanium spring.

In one embodiment, the spring receiving means can be made of stainless steel.

In yet another embodiment, the thread has at least a partially constant pitch.

In still yet another embodiment, the thread has a constant pitch.

In one embodiment, the thread has at least a partially variable pitch. A variable pitch provides the spring deformation and spring force to be built up slowly into the clamping point. The resulting tendency of the spring to jump out is thereby distinctly reduced.

In yet another embodiment, there is provided at least one other or second thread portion with a first constant pitch.

Furthermore, in still yet another embodiment, there is provided another or third thread portion with a variable or a first variable pitch.

In still yet another embodiment, provided is another or fourth thread portion with a variable or a second variable pitch.

In one embodiment, the thread is an external thread or an internal thread and/or the thread is a round thread, or a conical thread, or a rectangular thread, or a trapezoidal thread.

In one embodiment, the present invention includes a landing gear chassis for an aircraft. In yet another embodiment, provided is a landing gear chassis for an aircraft including at least one spring system as described above.

In yet still another embodiment, the present invention provided includes an aircraft having at least one spring system as described above. Accordingly, it is provided that an aircraft, more specifically, an airplane, includes at least one spring system as described above and/or at least one landing gear chassis with at least one spring system as described above.

### BRIEF DESCRIPTION OF THE DRAWINGS

FIG. 1 shows a perspective view of the spring system according to the invention in the loaded state;

FIG. 2 shows a perspective view of the spring system according to the invention in the partially loaded state;

FIG. 3 shows a perspective view of the spring system according to the invention in the unloaded state;

FIG. 4 shows a cross-sectional drawing of the spring system as shown in FIG. 3;

FIG. 5 shows a perspective drawing of a landing gear for an aircraft in an extended state; and

FIG. 6 shows a perspective drawing of a landing gear for an aircraft in the retracted state.

### DETAILED DESCRIPTION

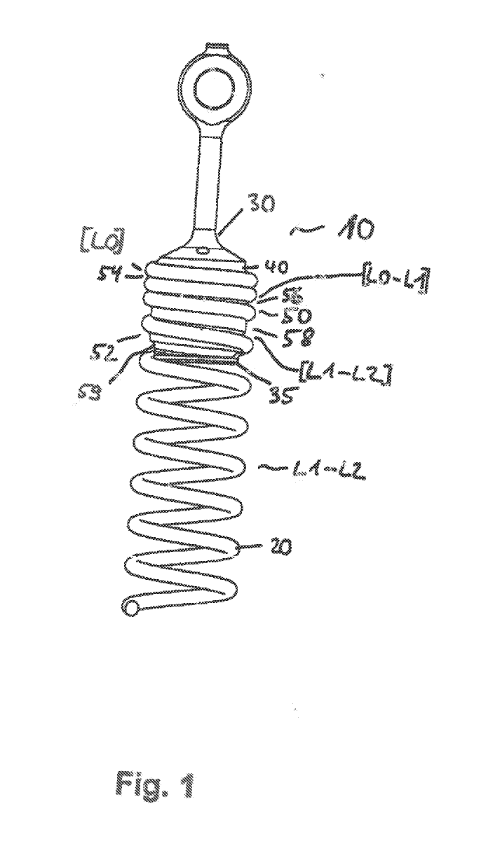

FIG. 1 shows a perspective view of the spring system 10 according to the invention in the loaded state, here the deflection of the spring 20 to a length in the range L1-L2 is shown.

In the Figures, the spring pitch is provided such that the spring pitch within designated ranges is indicated in brackets with reference to the length of the spring corresponding to this spring pitch having a corresponding deflection.

In one aspect, the spring system according to the invention includes a reduction of the deformations and forces at the transition from the fixed region to the resilient region of the spring 20. This is achieved by fastening the spring 20 to the thread 50 having variable pitch. The spring deformations and forces are thereby built up slowly into the clamping point.

The thread pitch of the thread 50 increases continuously from the thread portion 54, with a first constant spring pitch [L0] at the head of the spring 20. The pitch of the thread 50 at the end of the spring is approximately the pitch of the spring [L1], or may be approximately a spring pitch between [L1-L2].

Therefore, at the transition from the fixed region to the resilient region of the spring 20, the spring 20 is thereby pre-tensioned and pre-deformed to the values that would occur during normal operation or use of the spring 20.

The thread 50 may be cut or milled into the lug head 40, wherein the lug head 40 is part of the spring receiving means 30. The spring receiving means 30 also includes a cylinder portion 35, over which the spring 20 can be pushed. The cylinder portion 35 may also be designed such that it stabilizes the spring 20 from the inside of the spring 20, and more specifically, when the cylinder portion 35 is designed with a length greater than is shown in FIGS. 1-4.

Thread 50 is divided into different portions. One portion is thread portion 52 having a thread pitch [L1-L2] within the operating pitch of the spring 20. Another portion, thread portion 54, has two thread grooves with a constant pitch [L0]. In yet another thread portion is thread portion 56, having one thread groove with a variable pitch of [L0-L1]. Lastly, is thread portion 58 having a variable pitch of [L1-L2].

The portions 52 and 58 may overlap, as in one exemplary embodiment, however, the overlap of portions 52 and 58 are not necessary.

The thread groove 59 within the thread portion 58 may be widened or lined. As a result, facilitation of the mounting of the spring 20 is realized and the spring 20 may be decompressed in a controlled fashion using the flank of the first thread groove facing away from the lug head 40 via varying the length (i.e., L1 to L2, or vice versa). This relieves stress and deformation peaks.

In principle, it is also conceivable that the thread or individual thread portions are tapered or set at lower levels. The thread shape can be, without limitation, round or any other applicable shape (e.g., rectangular or trapezoidal). The requirements placed on the spring system can also be satisfied by threads with constant pitch that lie within the range of the operating pitch [L1-L2]. In principle, it is also possible that the thread 20 is designed as internal thread. To secure the attachment of the spring 20 to the lug head 40, adhesives and/or similar elements (e.g., a shrink sleeve, or the like) can be used.

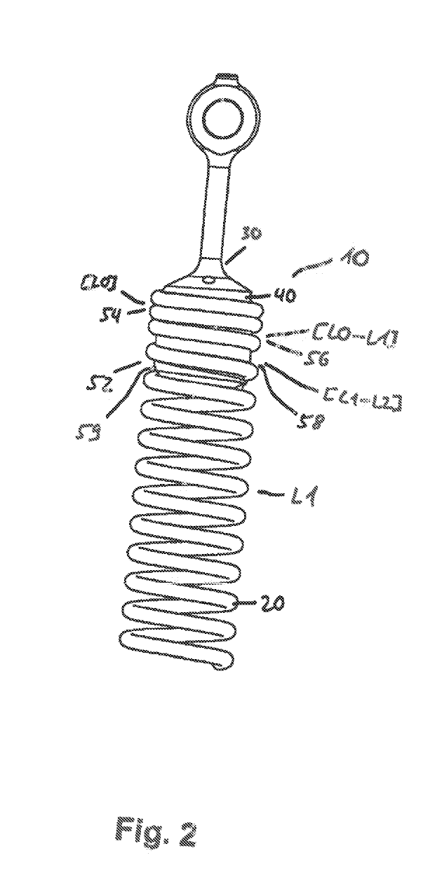

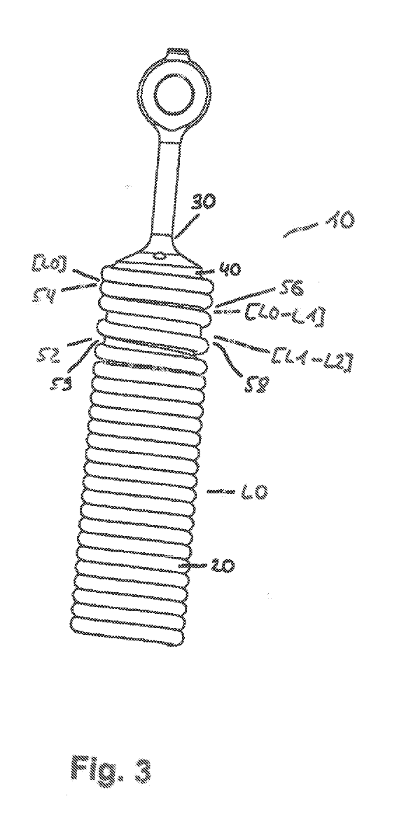

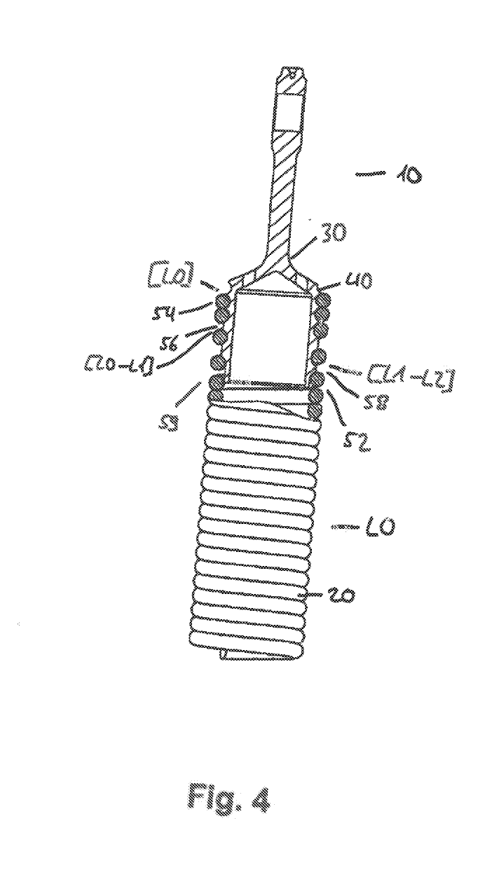

FIGS. 2 and 3 show a perspective view of the spring system 10, according to the invention, in the partly loaded state (cf. FIG. 2) with a deflection to a length L1, or in the partly unloaded state (cf. FIG. 3) with a deflection to a length L0. FIG. 4 shows a cross-sectional drawing of the spring system 10 shown in FIG. 3.

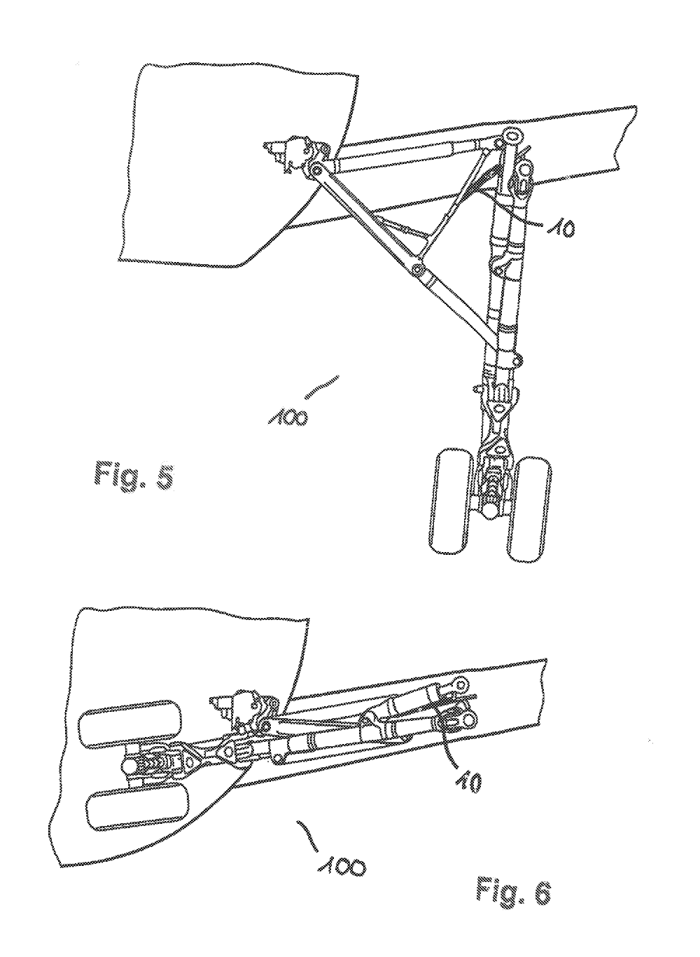

FIG. 5 shows a perspective drawing of a landing gear chassis of an aircraft in the extended state. The landing gear chassis 100 of the aircraft includes the spring system 10 of the invention. FIG. 6 shows the landing gear chassis 100 of the aircraft, as shown in FIG. 5, conversely in the retracted state.

1. A spring system comprising:
at least one spring; and
at least one spring receiver comprising at least one lug head to which the spring is attachable or is attached, wherein the lug head comprises a thread onto which the spring can be screwed on or is screwed on, and the thread comprises at least one thread portion comprising a thread pitch in the range of an operating pitch of the spring.

2. The spring system according to claim 1, wherein the thread further comprises at least a partially constant pitch.

3. The spring system according to claim 2, wherein the thread further comprises a constant pitch.

4. The spring system according to claim 1, wherein the thread further comprises at least a partially variable pitch.

5. The spring system according to claim 4, wherein at least one other or second thread portion comprises a first constant pitch.

6. The spring system according to claim 5, wherein another or third thread portion comprises a variable or a first variable pitch.

7. The spring system according to claim 5, wherein another or fourth thread portion comprises a variable or a second variable pitch.

8. The spring system according to claim 1, wherein the thread comprises an external thread or an internal thread and/or wherein the thread comprises a round thread or a conical thread or a rectangular thread or a trapezoidal thread.

9. A landing gear chassis comprising at least one spring system according to claim 1.

10. An aircraft comprising at least one spring system according to claim 1.

11. An aircraft comprising at least one landing gear chassis according to claim 9.
